(19) United States
(12) Patent Application Publication
(10) Pub. No.: US 2003/0042201 A1
(43) Pub. Date: Mar. 6, 2003

(54) Medical grade water production system

(76) Inventors: Mark L. Sizelove, St. Helena, CA (US); Michael A. Taylor, Napa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/177,718

(22) Filed: Jun. 19, 2002

Related U.S. Application Data
(60) Provisional application No. 60/299,688, filed on Jun. 19, 2001.

(51) Int. Cl. B01D 36/00

(52) U.S. Cl. 210/639; 210/650; 210/669; 210/295; 210/266; 210/202

(57) ABSTRACT

A point-of-use apparatus and methods for producing medical grade drinking water. Preferred embodiments encompass the use of one or more beneficial reagent delivery devices with which the medical grade drinking water can be fortified with various vitamins, minerals, and various pharmaceutical products.

### RELATED APPLICATIONS

This application claims priority to U.S. provisional patent application serial No. 60/299,688, filed Jun. 19, 2001, which is hereby incorporated by reference in its entirety.

### BACKGROUND OF THE INVENTION

An increasing number of debilitated individuals are able to live within the community rather than being restricted to hospital environments. These individuals suffer from a number of medical conditions, including chronic diseases, immuno-suppressing diseases or conditions cause by disease or resulting from various therapeutic regimes, and simply, advanced age. Such debilitated individuals are highly susceptible to the deleterious effects of water-borne contaminants that do not generally harm non-debilitated individuals. Moreover, more of these individuals are in the general public rather than living in a protective hospital settings. Thus, the population of debilitated individuals in the general public is increasing.

There are numerous types of water-borne contaminants. For example, a number of otherwise non-pathogenic agents including parasites, protozoa, fungi, bacteria and viruses can be considered water-borne contaminants to individuals whose immune systems are unable to combat them. Various chemical agents can also have deleterious effects on debilitated individuals, thus making these agents water-borne contaminants.

The levels of many chemical contaminants approved by the U.S. Environmental Protection Agency (EPA) can be potentially harmful to debilitated individuals. For example, individuals with chronic renal failure or congestive heart failure consuming water containing relatively high levels of sodium or chloride (500 mg/mL) would suffer detrimental effects from the consumption of high levels of these salts.

The water-borne contaminants present in municipally treated water supplies vary widely from location to location and from season to season. Large volumes of particulate materials and biological agents can enter municipal water supplies after water treatment. Municipal treatment does not provide the same purification capability as point-of-use purification. Accordingly, such water-borne contaminants can pose a serious safety hazard to debilitated individuals.

A medical grade water standard and a system for point-of-use production of this grade of water would provide a greater level of safety for debilitated individuals.

### SUMMARY OF THE INVENTION

This present disclosure describes a point-of-use water purification system to produce medical grade drinking water. In a preferred embodiment, the system comprises a purification segment with which medical grade drinking water is produced. In another preferred embodiment, the system comprises a purification segment and one or more beneficial agent delivery segment. The purification segment typically comprises purification components for removal of undesirable particulates, microbial agents, and their by-products. Purification is achieved by filtration and chemical adsorption and/or ionic interaction. The purification segment produces drinking water free of potential infectious agents and reduced levels of potentially harmful chemical agents.

The purification segment components remove microbiological contaminants and their by-products and viruses. The purification segment also removes chemical contaminants such as: organic and inorganic chemicals (including low levels of pesticides and heavy metals such as aluminum, lead, iron), dissociable ionic materials (including salts containing sodium, chloride, magnesium, phosphorous, other halides, and other cations or anions), as well as other dissolved solids. The product water from the described purification device produces a standard drinking water that minimizes the potential hazards associated with potable drinking water for individuals with chemical sensitivities, opportunistic infection susceptibility or environmental illness.

A Medical Grade Drinking Water Standard is provided below. The Standard provides the user with a basis of understanding of the quality of the water described under that standard. Augmentation of the drinking water with essential nutrients to maintain health in debilitated individuals. Water meeting this standard does not represent a hazard to debilitated individuals that are susceptible to opportunistic infections or individuals sensitive to multiple chemical sensitivities or environmental illnesses.

The second component, the beneficial agent delivery device, contains various micronutrients, vitamins minerals, and other useful agents. In practice, the beneficial delivery device is attached to the purification segment down stream of the water source. Preferably, the beneficial agent delivery device contains the dietary reference intakes recommended by the National Academies of Sciences. It can be supplemented with patient specific nutritionals or other patient-specific agents. The beneficial agent delivery device will preferably contain one or more compression components that facilitate the dissolution of the beneficial agents into the medical grade drinking water. One or more beneficial agent devices can be used to produce fortified medical grade drinking water tailored to a particular patient's needs.

### BRIEF DESCRIPTION OF THE DRAWINGS

FIG. 1 shows a schematic representation of a point-of-use medical grade drinking water system.

FIG. 2 shows a cross-sectional view of a purification segment.

FIG. 3 shows a cross-sectional view of a beneficial reagent device.

### DETAILED DESCRIPTION OF THE PREFERRED EMBODIMENT

While the illustrated embodiments are described in the context of a particular application, i.e., providing medical grade drinking water, the skilled artisan will find application for the apparatus and methods for producing medical grade drinking water in a variety of applications. Moreover, the apparatus and methods for producing “medical grade drinking water” will have applications beyond the medical field, wherever similarly pure water is desirable. The fluid purification unit described herein has particular utility when connected in series upstream of fluid collection/delivery devices, such as the illustrated mechanism for mixing dry reagent as purified diluent flows through.

The invention described below relates to a standard of water purity that minimizes the presence of water-borne contaminants. Additionally, mechanisms for producing water of the prescribed standard of purity are also described. Water of the described purity is beneficial because it would allow debilitated individuals to imbibe municipally treated water without fear of succumbing to the health hazards attendant with the consumption of various water-borne contaminants.

Medical Grade Water Standard

Below is described a standard of water purity that is suitable for use by debilitated individuals who may be susceptible to disease caused by water-borne contaminants. The standard provides a grade of water that exceeds the requirements of the EPA Primary Drinking Water Standard for the mass population. Water meeting the described standard has reduced dissociable ions including salts containing sodium, chloride, halides, cations or anions, and reduced dissolved solids generally. Water meeting the standards articulated below has reduced organic and inorganic contaminants, including reduced levels of pesticides and heavy metals (lead, arsenic, iron, and mercury) when compared to such levels found in typical municipal water samples. Preferably, levels of microbial organisms, viruses, and the by-products of such organisms, such as endotoxins and exotoxins are lower in water meeting the described standards when compared to levels found in typical municipal water samples. In addition to removing water-borne contaminants, water meeting the described standards can be fortified with a variety of vitamins and minerals.

Water meeting the standards articulated below will contain a reduced level of water-borne contaminants that could threaten the health of a debilitated person, as described in the Background Section above. Preferred levels of inorganic chemicals present in water meeting the purity standards of the present invention include antimony at levels from about 0 to 0.0059 mg/L; arsenic at levels from about 0 to 0.049 mg/L; asbestos (fiber >10 micrometers) from about 0 to 6.999 mg/L; barium from about 0 to 1.999 mg/L; beryllium from about 0 to 0.0039 mg/L; cadmium from about 0 to 0.0049 mg/L; chromium (total) from about 0 to 0.099 mg/L; copper from about 0 to 1.299 mg/L; cyanide (as free cyanide) from about 0 to 0.199 mg/L; fluoride from about 0 to 3.999 mg/L; lead from about 0 to 0.0149 mg/L; inorganic mercury from about 0 to 0.0019 mg/L; nitrate (measure as nitrogen) from about 0 to 9.999 mg/L; nitrite (measured as nitrogen) from about 0 to 0.999 mg/L; selenium from about 0 to 0.049 mg/L; and thallium from about 0 to 0.00199 mg/L.

Preferred levels of organic chemicals present in water meeting the purity standards of the present invention include total levels of organic chemicals from 0 to 15.2999 mg/L; Acrylamide from about 0 to 0.1 mg/L; Alachlor from about 0 to 0.0019 mg/L; Atrazine from about 0 to 0.0029 mg/L; Benzene from about 0 to 0.0049 mg/L; Benzo(a)pyrene from about 0 to 0.00019 mg/L; Carbofuran from about 0 to 0.039 mg/L; Carbon tetrachloride from about 0 to 0.0049 mg/L; Chlordane from about 0 to 0.0019 mg/L; Chlorobenzene from about 0 to 0.099 mg/L; 2,4-D from about 0 to 0.069 mg/L; Dalapon from about 0 to 0.199 mg/L; 1,2-Dibromo-3-chloropropane from about 0 to 0.00019 mg/L; o-Dichlorobenzene from about 0 to 0.599 mg/L; p-Dichlorobenzene from about 0 to 0.0749 mg/L; 1,2-Dichloroethane from about 0 to 0.0049 mg/L; 1-1-Dichloroethylene from about 0 to 0.0069 mg/L; cis/trans-1,2-Dichloroethylene from about 0 to 0.0069 mg/L; Dichloromethane from about 0 to 0.0049 mg/L; 1-2-DichloropropaneDi(2-ethylhexyl)adipate from about 0 to 0.399 mg/L; Di(2-ethylthexyl)phthalate from about 0 to 0.0059 mg/L; Dinoseb from about 0 to 0.0069 mg/L; Dioxin from about 0 to 2.9×10⁻⁹ mg/L; Diquat from about 0 to 0.019 mg/L; Endothall from about 0 to 0.099 mg/L; Endrin from about 0 to 0.0019 mg/L; Epichlorohydrin from about 0 to 1.9 mg/L; Ethylbenzene from about 0 to 0.69 mg/L; Ethelyne dibromide from about 0 to 4.9×10⁻⁵ mg/L; Glyphosate from about 0 to 0.69 mg/L; Heptachlor from about 0 to 3.9×10⁻⁴ mg/L; Heptachlor epoxide from about 0 to 1.9×10⁻⁴ mg/L; Hexachlorobenzene from about 0 to 0.0009 mg/L; Hexachlorocyclopentradiene from about 0 to 0.049 mg/L; Lindane from about 0 to 0.00019 mg/L; Methoxychlor from about 0 to 0.039 mg/L; Oxamyl from about 0 to 0.19 mg/L; Polychlorinated biphenyls from about 0 to 0.00049 mg/L; Pentachlorophenol from about 0 to 0.0009 mg/L; Picloram from about 0 to 0.49 mg/L; Simazine from about 0 to 0.0039 mg/L; Styrene from about 0 to 0.09 mg/L; Tetrachloroethylene from about 0 to 0.0049 mg/L; Toluene from about 0 to 0.9 mg/L; Total Trihalomethanes from about 0 to 0.099 mg/L; Toxaphene from about 0 to 0.0029 mg/L; 2,4,5-TP from about 0 to 0.049 mg/L; 1,2,4-Trichlorobenzene from about 0 to 0.069 mg/L; 1,1,1-Trichloroethane from about 0 to 0.19 mg/L; 1,1,2-Trichloroethane from about 0 to 0.0049 mg/L; Trichloroethane from about 0 to 0.0049 mg/L; Vinyl chloride from about 0 to 0.0019 mg/L; Xylenes (total) from about 0 to 9.99 mg/L; and Accumulated Total Organic Carbon from about 0 to 15.45 mg/L. Most preferably all of the above standards are met, although in some arrangements only some of the above standards are met, depending upon the user's needs.

Table 1 lists a variety of water-borne contaminants and levels at which such contaminants should be restricted to meet the purity standard articulated herein. The agents listed in Table 1 would be reduced from the levels indicated for the EPA Primary and Secondary Drinking Water Standards to the levels indicated for Medical Grade Water Standard in the first column of Table 1.

TABLE 1

| | Medical | | |
|---|---|---|---|
| | Grade Water | | MCL² or TT³ |
| Inorganic Chemicals | Standard | MCLG¹ | (mg/L)⁴ |
| Antimony | | 0.006 | 0.006 |
| Arsenic | 0 | none⁵ | 0.05 |
| Asbestos (fiber | <2 | 7 | 7 |
| >10 micrometers) | | | |
| Barium | 1 | 2 | 2 |
| Beryllium | 0.002 | 0.004 | 0.004 |
| Cadmium | 0.0025 | 0.005 | 0.005 |
| Chromium (total) | 0.05 | 0.1 | 0.1 |
| Copper | 0.05 | 1.3 | 1.3⁷ |
| Cyanide (as free cyanide) | 0.05 | 0.2 | 0.2 |
| Fluoride | 1 | 4 | 4 |
| Lead | 0 | zero | 0.015⁶ |
| Inorganic Mercury | 0.0005 | 0.002 | 0.002 |
| Nitrate (measure as Nitrogen) | 2.5 | 10 | 10 |
| Nitrite (measured as Nitrogen) | 0.5 | 1 | 1 |
| Selenium | 0.025 | 0.05 | 0.05 |
| Thallium | 0.0002 | 0.0005 | 0.002 |
| | | MCLG¹ | |
| | | (mg/L)⁴ - | MCL² or TT³ |
| Organic Chemicals | | ppm | (mg/L)⁴ |
| Total | | 15.31 | 15.47 |
| Acrylamide | 0 | 0 | TT⁷ |
| Alachlor | 0 | 0 | 0.002 |
| Atrazine | 0.001 | 0.003 | 0.003 |
| Benzene | 0 | 0 | 0.005 |
| Benzo(a)pyrene | 0 | 0 | 0.0002 |
| Carbofuran | 0.02 | 0.04 | 0.04 |
| Carbon tetrachloride | 0 | 0 | 0.005 |
| Chlordane | 0 | 0 | 0.002 |
| Chlorobenzene | 0.05 | 0.1 | 0.1 |
| 2,4-D | 0.035 | 0.07 | 0.07 |
| Dalapon | 0.1 | 0.2 | 0.2 |
| 1,2-Dibromo-3-chloropropane | 0 | 0 | 0.0002 |
| o-Dichlorobenzene | 0.3 | 0.6 | 0.6 |
| p-Dichlorobenzene | 0.03 | 0.075 | 0.075 |
| 1,2-Dichloroethane | 0 | 0 | 0.005 |
| 1-1-Dichloroethylene | 0.003 | 0.007 | 0.007 |
| cis/trans-1,2-Dichloroethylene | 0.03 | 0.07 | 0.07 |
| Dichloromethane | 0 | 0 | 0.005 |
| 1-2-Dichloropropane | 0 | 0 | 0.005 |
| Di(2-ethylhexyl)adipate | 0.2 | 0.4 | 0.4 |
| Di(2-ethylthexyl)phthalate | 0 | 0 | 0.006 |
| Dinoseb | 0.003 | 0.007 | 0.007 |
| Dioxin | 0 | 0 | 0.000000003 |
| Diquat | 0.01 | 0.02 | 0.02 |
| Endothall | 0.05 | 0.01 | 0.1 |
| Endrin | 0.001 | 0.002 | 0.002 |
| Epichlorohydrin | 0 | 0 | TT 2 ppb⁷ |
| Ethylbenzene | 0.3 | 0.7 | 0.7 |
| Ethelyne dibromide | 0 | 0 | 0.00005 |
| Glyphosate | 0.3 | 0.7 | 0.7 |
| Heptachlor | 0 | 0 | 0.0004 |
| Heptachlor epoxide | 0 | 0 | 0.0002 |
| Hexachlorobenzene | 0 | 0 | 0.001 |
| Hexachlorocyclopentradiene | 0.025 | 0.05 | 0.05 |
| Lindane | 0.00002 | 0.0002 | 0.0002 |
| Methoxychlor | 0.01 | 0.04 | 0.04 |
| Oxamyl | 0.05 | 0.2 | 0.2 |
| Polychlorinated biphenyls | 0 | 0 | 0.0005 |
| Pentachlorophenol | 0 | 0 | 0.001 |
| Picloram | 0.1 | 0.5 | 0.5 |
| Simazine | 0.002 | 0.004 | 0.004 |
| Styrene | 0.05 | 0.1 | 0.1 |
| Tetrachloroethylene | 0 | 0 | 0.005 |
| Toluene | 0.5 | 1 | 1 |
| Total Trihalomethanes | 0 | none⁵ | 0.1 |
| Toxaphene | 0 | 0 | 0.003 |
| 2,4,5-TP | 0.02 | 0.05 | 0.05 |
| 1,2,4-Trichlorobenzene | 0.03 | 0.07 | 0.07 |
| 1,1,1-Trichloroethane | 0.01 | 0.2 | 0.2 |
| 1,1,2-Trichloroethane | 0.001 | 0.003 | 0.005 |
| Trichloroethane | 0 | 0 | 0.005 |
| Vinyl chloride | 0 | 0 | 0.002 |
| Xylenes (total) | 1 | 10 | 10 |
| Accumulated Total Organic | | | 15.46675 |
| Carbon | | | |
| | | MCLG¹ | MCL² or TT³ |
| Microorganisms | | (mg/L)⁴ | (mg/L)⁴ |
| Giardia lamblia | Zero | zero | TT⁸ |
| Cyposporidium sp. | Zero | | |
| Heterotrophic plate count | Zero | N/A | 500⁸ |
| Legionella | Zero | zero | TT⁸ |
| Total mycosis | Zero | | |
| Total protoza | Zero | | |
| Total parasites and spores | Zero | | |
| Total Coliforms^{9,10} | Zero | | |
| Turbidity | 2 | N/A | TT⁸ |
| Viruses | Zero | zero | TT⁸ |

| | Medical | Secondary |
|---|---|---|
| | Standard | Standard |
| Contaminant | (mg/L) | (mg/L) |
| Aluminum | 0.05 | 0.05 to 0.2 |
| Chloride | 50 | 250 |
| Copper | 0.5 | 1.0 |
| Corrosivity | Noncorrosive | Noncorrosive |
| Fluoride | 1.0 | 2.0 |
| Foaming Agents | 0.25 | 0.5 |
| Iron | 0.1 | 0.3 |
| Manganese | 0.02 | 0.05 |
| Odor | 2 | 3 |
| PH | 6.5-7.5 | 6.5-8.5 |
| Silver | 0.5 | 0.10 |
| Sulfate | 50 | 250 |
| Total Dissolved Solids | 150 | 500 |
| Zinc | 2 | 5 |

¹Maximum Contaminant Level Goal (MCLG)-The maximum level of a contaminant in drinking water at which no known or anticipated adverse effect on the health effect of persons would occur, and which allows for an adequate margin of safety. MCLGs are nonenforceable public health goals.
²Maximum Contaminant Level (MCL)-The maximum permissible level of a contaminant in water which is delivered to any user of a public water system, MCLs are enforceable standards. The margins of safety in MCLGs ensure that exceeding the MCL slightly does not pose significant risk to public health.
³Treatment Technique-An enforceable procedure or level of technical performance which public water systems must follow to ensure control of a contaminant.
⁴Units are in milligrams per Liter (mg/L) unless otherwise noted.
⁵MCLGs were not established before the 1986 Amendments to the Safe Drinking Water Act. Therefore, there is no MCLG for this contaminant.
⁶Lead and copper are regulated in a Treatment Technique which requires systems to take tap water samples at sites with lead pipes or copper pipes that have lead solder and/or are served by lead service lines. The action level, which triggers water systems into taking treatment steps if exceeded in more than 10% of tap water samples, for copper is 1.3 mg/L, and for lead is 0.015 mg/L.
⁷Each water system must certify, in writing, to the state (using third-party or manufacturer's certification) that when acrylamide and cpichlorohydrin are used in drinking water systems, the combination (or product) of dose and monomer level does not exceed the levels specified, as follows:
Acrylamide = 0./05% dosed at 1 mg/L (or equivalent)
Epichlorohydrin = 0.01% dosed at 20 mg/L (or equivalent)
⁸The Surface Water Treatment Rule requires systems using surface water or ground water under the direct influence of surface water to (1) disinfect their water, and (2) filter their water or meet criteria for avoiding filtration so that the following contaminants are controlled at the following levels:
Giardia lamblia: 99.9% killed/inactivated
Viruses: 99.99% killed/inactivated
Legionella: No limit, but EPA believes that if Giardia and viruses are inactivated, Legionella will also be controlled
Turbidity: At no time can turbidity (cloudiness of water) go above 5 nephelolometric turbidity units (NTU); systems that filter must ensure that the turbidity go no higher than 1 NTU (0.5 NTU for conventional or direct filtration) in at least 95% of the daily samples in any month.
HPC: NO more than 500 bacterial colonies per milliliter.
⁹No more than 5.0% samples total coliform-positive in a month. (For water systems that collect fewer than 40 routine samples per month, no more than one sample can be total coliform-positive). Every sample that has total coliforms must be analyzed for fecal coliforms. There cannot be any fecal coliforms.
¹⁰Fecal coliform and E. coli are bacteria whose presence indicates that the water may be contaminated with human animal wastes. Microbes in these wastes can cause diarrhea, cramps, nausea, headaches, or other symptoms.
Beneficial Agents

In addition to removing harmful or potentially harmful material, the methods described herein can be used to generate nutrient enriched water supplies without agitation. Preferably, medical grade drinking water is provided to a beneficial agent delivery device which is used to dilute various beneficial agents. For example, the following vitamins and minerals can be added to water purified to the prescribed levels to benefit the consumer. Vitamin A can be added to medical grade water at final concentration of from about 0 to 5000 International Units (IU), preferably from about 10 to 1000 IU, and more preferably from about 100 to 500 IU per purified water volume. Vitamin C can be added to medical grade water at a final concentration of from about 0 to 60 mg, preferably from about 10 to 50 mg, and more preferably from about 20 to 40 mg per purified water volume. Vitamin B1 can be added to medical grade water at a final concentration of from about 0 to 2 mg, preferably from about 0.5 to 1 mg, and more preferably from about 0.75 to 0.9 mg per purified water volume. Vitamin B2 can be added to medical grade water at a final concentration of from about 0 to 2 mg, preferably from about 0.5 to 1 mg, and more preferably from about 0.75 to 0.9 mg per purified water volume. Niacin can be added to medical grade water at a final concentration of from about 0 to 20 mg, preferably from about 5 to 15 mg, and more preferably from about 7.5 to 10 mg per purified water volume. Calcium can be added to medical grade water at a final concentration of from about 0 to 1 g, preferably from 0.1 to 0.75 g, and more preferably from 0.25 to 0.50 g per purified water volume. Iron can be added to medical grade water at a final concentration of from about 0 to 20 mg, preferably from about 5 to 15 mg, and more preferably from about 7.5 to 10 mg per purified water volume. Vitamin D can be added to medical grade water at a final concentration of from about 0 to 400 IU, preferably from 100 to 300 IU, and more preferably from 150 to 250 IU per purified water volume. Vitamin E can be added to medical grade water at a final concentration of from about 0 to 30 IU; preferably from 5 to 20 IU, and more preferably from about 10 to 15 IU per purified water volume. Vitamin B6 can be added to medical grade water at a final concentration of from about 0 to 2 mg, preferably about 0.5 to 1.5 mg, and more preferably 0.75 to 1.0 mg per purified water volume. Folic Acid an be added to medical grade water at a final concentration of from about 0 to 0.4 mg, preferably from 0.1 to 0.3 mg, and more preferably from 0.15 to 0.25 mg per purified water volume. Vitamin B12 can be added to medical grade water at a final concentration of from about 0 to 6 μg, preferably from 2 to 4 μg, and more preferably from about 2.5 to 3.5 μg per purified water volume. Biotin can be added to medical grade water at a final concentration of from about 0 to 0.3 mg, preferably 0.05 to 0.25 mg, and more preferably 0.1 to 0.2 mg per purified water volume. Pantothenic acid can be added to medical grade water at a final concentration of from about 0 to 10 mg, preferably from about 2 to 7 mg, and more preferably from 3 to 5 mg per purified water volume. Phosphorus can be added to medical grade water at a final concentration of from about 0 to 1 g, preferably from about 0.2 to 0.8 g, and more preferably from 0.3 to 0.5 g per purified water volume. Iodine can be added to medical grade water at a final concentration of from about 0 to 150 μg, preferably 20 to 100 μg, and more preferably 30 to 50 μg per purified water volume. Magnesium can be added to medical grade water at a final concentration of from about 0 to 400 mg, preferably from about 50 to 300 mg, and more preferably from about 100 to 200 mg per purified water volume. Zinc can be added to medical grade water at a final concentration of from about 0 to 15 mg, preferably from 5 to 12 mg, and more preferably from 7.5 to 10 mg per purified water volume. Copper can be added to medical grade water at a final concentration of from about 0 to 2 mg, preferably from about 0.5 to 1 mg, and more preferably from about 0.75 to 0.9 mg per purified water volume. Any combination of the agents listed above or a variety of other beneficial agents can also be added to fortify the water purified to the prescribed purity levels.

A variety of beneficial agents are listed in Table 2.

TABLE 2

| Vitamins and | Medical Water | | | |
|---|---|---|---|---|
| Minerals | Supplement | | 100% USRDA | |
| A | 1,000 retinal equivalents | | 1,000 retinol equivalents | |
| | (RE) or 5,000 | | (RE) or 5,000 | |
| | International Units (IU) | | International Units (IU) | |
| C | 60 | mg | 60 | mg |
| B1 | 1.5 | mg | 1.5 | mg |
| B2 | 1.7 | mg | 1.7 | mg |
| Niacin | 20 | mg | 20 | mg |
| Calcium | 1 | g | 1 | g |
| Iron | 18 | mg | 18 | mg |
| D | 400 | IU | 400 | IU |
| E | 30 | IU | 30 | IU |
| B6 | 2 | mg | 2 | mg |
| K | | | | |
| Folic Acid | 0.4 | mg | 0.4 | mg |
| B12 | 6 | μg | 6 | μg |
| Biotin | 0.3 | mg | 0.3 | mg |
| Pantothenic acid | 10 | mg | 10 | mg |
| Phosphorus | 1 | g | 1 | g |
| Iodine | 150 | μg | 150 | μg |
| Magnesium | 400 | mg | 400 | mg |
| Zinc | 15 | mg | 15 | mg |
| Copper | 2 | mg | 2 | mg |

Purification System

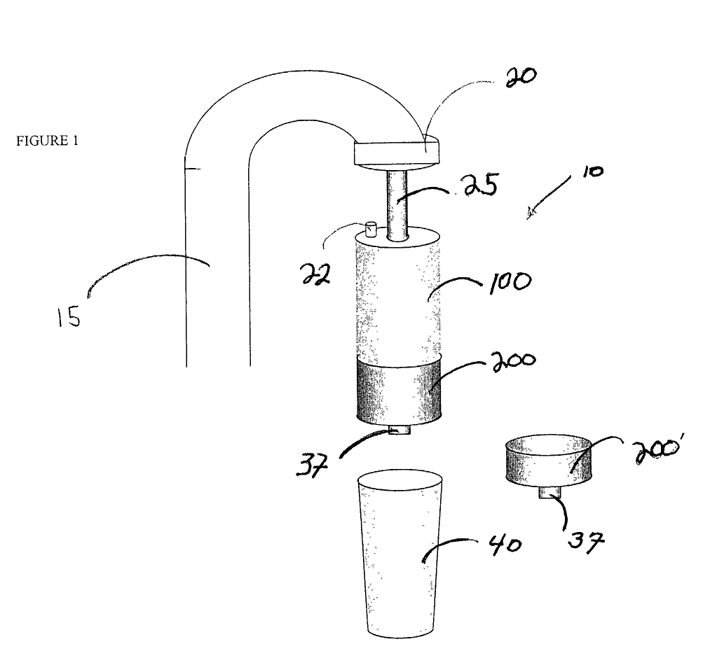

FIG. 1 shows a schematic representation of a preferred embodiment of the disclosed water purification system. The system 10 includes a water supply 15 that is coupled to downstream components by a coupling unit 20. The coupling unit 20 is in fluid communication with a water delivery tube 25, which in turn is attached to a purification segment 100. The depicted embodiment also shows a beneficial agent segment , which is shown connected to the purification segment 100. Optionally, one or more additional beneficial agent segments having the same or different beneficial agents contained therein can be used with the disclosed system 10. Processed water emerging from the purification segment 100 emerges from outlet 37 and into the optional beneficial agent segment 200 or segments 200′ is collected in a container 40. In FIG. 1, the container 40 is a glass; however, other containers such as bottles, bags, etc. are also suitable for use with the system 10.

The source water can be supplied to the purification segment 100 by attachment to a faucet 15 via the coupling unit 20. Alternatively, a fill bag can be attached to the coupling unit 20, when tap water is not available. A pressure relief valve 22 is provided. In the illustrated embodiment, the relief valve is attached to the purification segment 100. The relief valve may be located anywhere on or between the coupling unit 20, the water delivery tube 25, or the purification segment 100. When source water is obtained from a tap, it is preferred that a relief valve 22 is present to prevent damaging pressure from being applied to the purification segment 100.

A preferred embodiment will also comprise a water quality sensor, usually located downstream of the purification segment 100 and upstream of any beneficial agent segments. In one embodiment, the sensor measures current conducted through the water emerging from the purification segment 100, to measure the conductance of the water leaving the purification segment 100. In this embodiment, the sensor comprises a pair of electrodes. The sensor may optionally be connected to a warning indicated, such as a light or sound generated. The sensor can cause a warning signal to be generated when the conductance of water emerging from the purification segment 100 reaches a prescribed maximum conductance. Assurance of water quality can be enhanced with incorporation of additional sensors for detection of organics carbon based materials including biologicals and pH sensors.

Purification Segment

A preferred water purification segment is capable of purifying water or other liquid diluent to the above-described standards. Advantageously, available water, preferably potable water, can be introduced to the system, and is purified as it flows through the pack, thus producing medical grade drinking water. The purified water can be delivered, for example, directly to a receptacle for drinking, such as a glass. In alternative embodiments, however, the purified water can be delivered to a beneficial reagent pack or a drug pack for use as a diluent with which reagents stored in the packs can be diluted and prepared for consumption. Accordingly, purified water need not be stored long in advance of its need or transported great distances to the point of administration. Complex machinery for purifying water is also obviated.

As discussed above, certain segments of the population with particular health needs require drinking water that is substantially purer than municipally produced tap water. A preferred purification segment 100 produces water of a quality suitable for consumption by such debilitated individuals. Water so purified will meet or exceed the medical grade water standards provided in column 1 of Table 1, especially with respect to sterility, pH, ammonia, calcium, carbon dioxide, chloride, sulfate and oxidizable substances. In particular, medial grade drinking water or other fluids produced by the system illustrated in FIGS. 1-3 exhibit the following characteristics: a very low level of total organic carbon, preferably less than about 1 ppm and more preferably less than about 500 ppb; low conductivity, preferably less than about 5.0 μSiemens (2.5 ppm) and more preferably less than about 2.0 μSiemens (1 ppm); near neutral pH, preferably between about 4.5 and 7.5, and more preferably between about 5.0 and 7.0; very low particulate concentration, preferably fewer than less than about 12 particles/mL of particles ≧10 μm, more preferably less than about 6 particles/mL of such particles, and preferably less than about 2 particles/mL of particles ≧25 μm, more preferably less than about 1 particle/mL of such particles; and low endotoxin levels, preferably less than about 0.25 endotoxin units (EU) per mL (0.025 ng/mL), more preferably less than about 0.125 EU/mL (0.0125 ng/mL) with a 10:1 EU/ng ratio.

Conventionally, purifying non-sterile fluid to such stringent quality standards, particularly for drinking water applications has not been achieved on a point-source production standard. One reason for the failure of municipalities to produce such high-grade drinking water is that most people in good health do not require such pure drinking water. Moreover, the need for extensive mechanical filtration and/or distillation, pumping, distribution and monitoring systems makes the large-scale production and distribution of such high-grade drinking water impractical from a cost standpoint.

U.S. Pat. No. 5,725,777 to Taylor (the Taylor '777 patent) discloses a portable apparatus for purifying water to injectable quality. The apparatus includes several stages for purification, including multistage depth prefiltering, ultrafiltration fibers, reverse osmosis fibers, ion exchange resin and activated carbon in that order.

The reverse osmosis stage of the Taylor '777 patent effectively purifies water to a high degree. Unfortunately, because reverse osmosis involves diffusing input water across a semi-permeable membrane, the rate of water production is very slow relative to the cross-section of the membrane. Even with the use of multiple reverse osmosis fibers with a high overall membrane surface area, diffusion is slow. In order to fully realize the advantages of portability, purified diluent should be rapidly produced at the time of administration. For acceptable rates using the apparatus of the Taylor '777 patent, however, high pressures (e.g., 40 to 75 psi) are applied across the semi-permeable membrane. Pumps and restrictor means for realizing these pressures reduce the versatility and portability of the overall system.

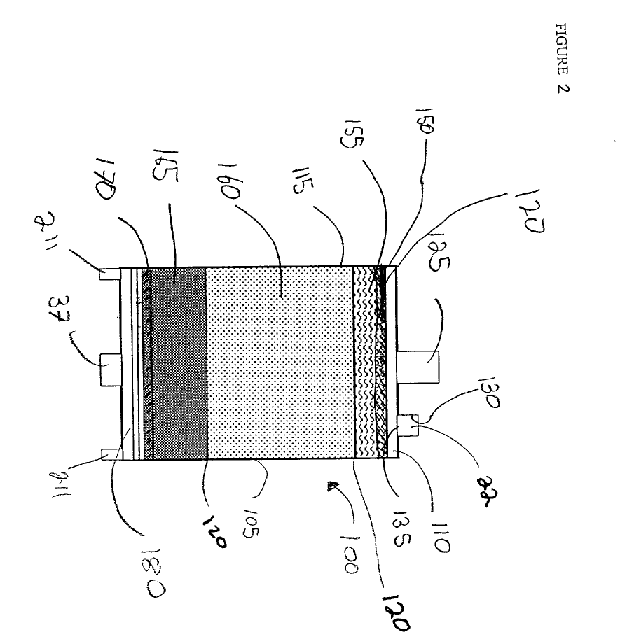

FIG. 2 shows a more detailed, representation of a purification segment 100. The purification segment 100 comprises of a housing 105, which is composed of a cover 110 and the housing body 115. The housing 105 is preferably composed of one or more molded polymeric materials, including but not restricted to polycarbonate, polypropylene, ABS, polystyrene, polyethylene and polyurethane; metals; glass; or combinations of these materials. The size of the purification segment 100 can range from an internal volume of 100 mL to 5 liters, preferably between 100 mL and 1 liter, and more preferably between 100 and 500 mL. The external dimensions can range from a diameter of 1 inch to 1 foot, preferably between 1.23 inches and 6 inches, and more preferably between 1.5 inches and 3 inches with a height between 1 inch and 2 feet, preferably between 2 inches and 1 foot, more preferably between 3 inches and 9 inches. The capacity of the purification segment 30 can range from 500 mL to 10 liters, preferably between 1 and 5 liters, more preferably 3 liters. A preferred embodiment of the water purification segment is capable of use while being held in a user's hands.

As shown in FIG. 2, the cover 110 fits into the housing body 115 and is sealed in place. A water-tight seal is provided by joining the cover 110 with the housing body 115 using any one of a number of sealing techniques well known to those of ordinary skill in the art. The skilled artisan will appreciate that the cover 110 and the housing body 115 can be joined, for example, using various welding techniques, such as ultrasonic or rotational welding. The technique used to join the cover 110 and the housing body 115 will depend on the nature of the material used for the cover and housing body.

The cover 110 shown in FIG. 2 contains a relief valve or vent 22 and a water inlet 125. The water inlet 125 enables access to the contents of the housing 105. The vent 22 allows air entrapped within the housing 115 to be released. The vent 12 comprises a gas port 130 and a gas permeable filter 135. In a preferred embodiment, the gas permeable filter 135 is composed of hydrophobic materials that can be reversibly wetted and dried when a gas like air is encountered. A space can be provided before the permeable filter 135 within the housing 115 to permit gas passage through the gas port 130 regardless of orientation of the purification segment 100.

The components within the housing 105 typically comprise a manifold or fluid distribution chamber 120, a component stabilization component 150, a depth filter 155, a dissociable ion removal component 160, an organics retention component 165, a filtration component 170, a fluid collection chamber 180 and a housing outlet 185.

Adjacent to the inlet 125 on the interior of the cover 110 is the fluid distribution chamber 120. The illustrated distribution chamber 120 comprises a space between the cover 110 interior, stabilization component 150, and the depth filter 155. Distributed within the space can be supporting ribs with intermittent gaps that form flow channels for source water distribution across the housing 105, within the fluid distribution channel 120.

The stabilization component 150 consists of a macroporous material layer that can be composed of, but is not restricted to, open cell foams, woven or non-woven materials which, upon hydration, expand to fill the otherwise unoccupied space around the stabilization component. In a preferred embodiment, the stabilization component 150 is composed of a cellulose-based material or pliable polymer, such as polyurethane, polyethylene and polypropylene.

The depth filter 155 preferably comprises a macroporous filter of polymeric materials or woven or non-woven fibers. Alternately this component could comprise polymeric, acrylic or gel resin beads of controlled porosity. The pore sizes of this filter can range from 1 micron to 500 microns, preferably between 5 microns and 100 microns, and more preferably between 10 microns and 25 microns.

The dissociable ion removal component 160 preferably consists of deionizing materials that act as ion exchangers. Suitable materials include charged polymeric, acrylic, or gel resin beads, a charged membrane, one or more charged filters, or a combination of these materials. The depth filter 155 can be located adjacent to the fluid distribution chamber 120 or adjacent to the downstream filtration component 170.

The organic retention component 165 is typically composed of a bed or block of carbon or synthetic substitute for carbon or a membranous material or filter capable of adsorption of carbonaceous materials.

The filtration component 170 typically comprises one or more microfiltration, nanofiltration, ultrafiltration, and/or reverse osmosis filters, or a combination of these filters. These components can be formed in dead-end, pleated or spiral wound configurations. The porosity of the microfiltration component is preferably between 0.1 and 1 micron, more preferably between 0.1 and 0.45 microns and most preferably between 0.2 and 0.22 microns. The ultrafiltration membrane porosity is preferably between 1,000 and 1,000,000 molecular weight cut off (MWCO), more preferably between 5,000 and 100,000 MWCO, and most preferably between 10,000 and 15,000 MWCO. The microporous, nanofiltration and ultrafiltration components can be composed of polymeric materials, including but not restricted to polysulfone, polyethersulfone, nylon, polytetrafluoroethylene (PTFE), or polyvinyl acetate. Any reverse osmosis membrane can be composed of thin layer film composite of cellulose acetate. The filtration component 170 can be strengthened by inclusion of a support. This can be composed of woven, non-woven or porous materials, including but not restricted to polyester, nylon, glass fiber, polyethylene, polyurethane, polyvinyl chloride, polyvinyl acetate, cellulose, glass or metal. The filtration components can also be impregnated with charges via chemical modification. These charges can be imparted by, but are not restricted to, use of quaternary amines, polysulfonic acids, or chloromethylation.

Proximate to the filtration component 170 and/or filtration support is the collection chamber 180. The collection chamber 180 typically comprises a space between the filtration component 170 and/or filtration support and housing outlet 37. The collection chamber 180 can be formed by supporting ribs with intermittent gaps that form flow channels for source water collection within the housing 105.

Mechanism of Action

Turning back to FIG. 1, medical grade water is produced by providing source water of the purification segment 100 via attachment to a coupling unit 20 (e.g. faucet connection). If the pressure from the source water exceeds acceptable limits the reversible pressure relief valve 22 opens bleeding off excess pressure. Once the pressure returns to acceptable limits, the pressure relief valve 22 closes.

Referring again to FIG. 2, upon entry into the housing 105, unpurified source water passes through the fluid distribution chamber 120 until it reaches the periphery of the housing 105. Unpurified source water then passes through the component stabilizer 150, the depth filter 155, the dissociable ions removal component 160, the organics retention component 165 to the filtration component 170. The stabilization component 150 serves to maintain the volume proportions of the components within the housing 105, by expansion or contraction, while allowing fluid flow. This component 150 also serves to provide gross filtration of particulates. Additional particulate filtration occurs when source water passes through the depth filter 155. This serves to reduce the potential for silt build-up, thus extending the capacity for retention of microscopic and sub-miscroscopic contaminants. The dissociable ions removal component 160 retains dissociable ions including, but not limited to, sodium, chloride, potassium, calcium; heavy metals including, but not limited, to lead, iron, arsenic, mercury; charged and polar organics; ionizing organics and inorganics; and other charged molecules and entities including, but not limited to, bacterial endotoxins.

The organics removal component 165 retains any residual organics including low molecular weight organics not retained by the dissociable ion component 160. Particulate matter, biologicals, microbes, microbiological by-products and viruses are also retained by the dissociable ion retaining component 160 and the organics retention component 165. The filtration component 170 retains insoluble particulates including, but not limited to, particulate matter, biologicals, microbes, microbiological by-products and viruses.

The purification capability of the purification segment 100 can be enhanced through the use of tangential flow of the filtration component by recirculation within the housing.

Purified, filtered water collects within the fluid collection chamber 180 and exits the purification segment 100 via the housing outlet 37 contacting the water quality sensor. The optional sensor provides an indicator of water quality by monitoring the conductance of the water contacting the electrodes. The ability of water to conduct a current is directly proportional to the level of dissolved solids present in the water. If the dissolved solids in the purification segment 100 are adequately reduced there is insufficient conductance to create a current between the electrodes, therefore the nominally open circuit remains open and the warning light off. If the level of dissolved solids increases a current form between electrodes closing the circuit and lights the warning light.

Preferably, the water purified using the apparatus described above produces water that meets or exceeds the standards articulated in Table 1, above.

Beneficial Agent Delivery Device

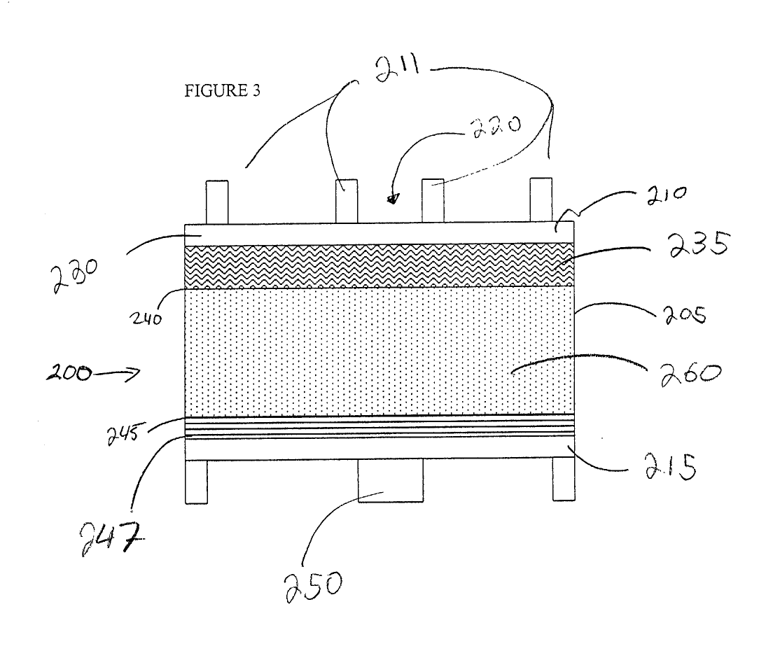

In addition to providing highly pure drinking water to individuals in a point-of-use adaptable manner, the described invention also has utility in preparing particular nutritional supplements to be imbibed with the described purified water. FIG. 3 illustrates one such beneficial agent delivery device 200.

For reference, U.S. Pat. No. 5,259,954, issued Nov. 9, 1993 (hereinafter “the '954 patent”) and U.S. Pat. No. 5,725,777, issued Mar. 10, 1998 (hereinafter “the '777 patent”), each issued to Taylor and incorporated by reference in their entireties, disclose drug packs for reagent modules suitable for storing dry reagents. Also incorporated by reference in its entirety is U.S. patent application Ser. No. 09/599,692, filed Apr. 27, 2000, entitled, “Improved Drug Delivery Pack”. Flowing a diluent fluid through the packs forms medical solutions. Various features of these devices are adapted for use with a variety of beneficial agents for the preparation of fortified drinking water. While the features and aspects of the invention described herein are particularly suitable for the preparation of fortified medical grade drinking water, the skilled artisan will readily find applications for many of the principles disclosed herein in other contexts.

Referring to FIG. 3, a beneficial agent (BA) delivery device 200 comprises a beneficial agent housing 205, including a BA cover 210 and a BA bottom 215. These components fit together by snap fit, welding or bonding. They can be composed of polymeric materials, including but not limited to polypropylene, polycarbonate, polyurethane, polystyrene, or ABS; or rigid materials like glass or metal. Within the device 200 is a BA housing inlet 220, which channels water from the purification segment 100 (FIG. 1) to the BA 205 housing interior. On the interior of the cover 210 is a fluid distribution chamber 230. It is formed by ribs projecting from the cover 210 preventing direct contact between a compression component 235 and the interior of the cover 210. A beneficial reagent bed 260 is shown below the compression component 235. One or more compression components can be used in a beneficial agent delivery device 200.

The compression component 235 described preferably comprises materials that have sponge-like elasticity and, as a result of compression, exert axial pressure while trying to return to its original, expanded form. The compression component preferably comprises compressible, porous, open cell polymer or foam designed to avoid generation of back-pressure. An exemplary material for the compression components is a polyurethane foam. Desirably, the compression component 235 in the housing 205 are arranged such that the compression component exerts a compressive force on the beneficial agent bed 260 regardless of the size of the reagent bed. In other words, the compression component 235 would, if left uncompressed, together occupy a greater volume than that defined by the housing 205. Desirably, the pressure exerted is between about 50 psi and 500 psi, more preferably between about 100 psi and 300 psi.

It will be understood that, in other arrangements, metal or polymer coiled springs and porous plates can serve the same function. Such alternative compression components are disclosed, for example, with respect to FIGS. 12-15; Col. 9, lines 8-53 of U.S. Pat. No. 5,725,777, the disclosure of which is incorporated herein by reference. It will also be understood, in view of the discussion below, that a single compression component can serve the function of the illustrated two compression components. Two components exerting pressure on either side of a beneficial agent bed 230 can also be advantageous in operation.

In an alternative embodiment, an elastomeric spring can be used as the compression component. The spring is particularly advantageous for applications where it is desirable to have a constant spring rate through a range of compression states and even pressure across the width of the spring.

A typical spring includes a top end, a bottom end, and at least one, preferably a plurality of adjacent and generally parallel spring columns extending between the ends. Each of the spring columns can comprise a series of undulating folds or loops along the spring axis. Each column has the shape that would be obtained if a planar strip of material were folded in alternating directions, in zigzag or accordion fashion, down the length of the strip. The loops can thus be considered the peaks and troughs of a waveform. In one embodiment, the spring columns can be joined at a bridge between adjacent inner loops to maintain even pressure on both sides of the spring.

A spring for use with a typical beneficial agent delivery device 200 is preferably molded from polyethylene, polypropylene, Delrin™ and other plastic resins that are bio-compatible with sensitive reagents. Preferably, the material is resilient and elastic to serve as the compression element of a beneficial agent delivery device 200.

The described spring is particularly constructed for fitting within a housing. A sidewall of such a housing, preferably cylindrical is a preferred cite of attachment. The maximum width of the spring is designed so that it matches the inner width of a housing within which the spring is designed to be fitted. In particular, the periphery of each end of the spring is designed to be equal to or slightly smaller than the housing sidewall, while the width of the fully compressed spring is equal to or slightly larger that of the ends of the spring. Thus, the spring self-centers within the housing defined by the sidewall.

The skilled artisan will recognize other features and advantages of the described spring for beneficial agent delivery or other applications, in view of the description herein.

The interior components of the device 200 shown in FIG. 3 comprise compression component 235, a BA reagent bed upper restraint 240, a lower bed restraint 245, and a bed of BA material 260. The compression component 235 is porous and elastic. It can be composed of, but is not limited to, sintered polymeric materials including polyethylene, polyester, polypropylene, PTFE, nylon, monosaccharide or disaccharide. The BA bed 260 can comprise water-soluble vitamins delivered in water, fat-soluble vitamins delivered as micelles or emulsions, and/or minerals delivered as slurry. Such agents are listed in Table 2. A fluid collection chamber 247 is formed by ribs projecting from the interior of the base of the BA housing 105, preventing contact of the lower BA bed restraint 245 from contacting the interior of the housing, particularly the housing bottom 215. The BA housing terminates in an outlet 250.

Mechanism of Action

The beneficial agent (BA) housing 200 can be attached to the purification segment 100 by interlocking ridges 211 on the exterior of the base of the purification segment 100 and exterior of the top of the BA device 200. Purified water exiting the purification segment 100 enters the BA device 200 via the inlet 220. This water disperses to the periphery of the BA housing 205 by the distribution chamber 230 via the channels formed by the cover ribs. Following dispersal, the water penetrates the compression component 235, the upper BA bed restraint 240, the BA bed 260 and the lower BA bed restraint 245. In this manner the BA bed restraints are acted upon by the water to facilitate release of the entrapped BA in the bed 260. Released BA enters the fluid collection chamber 235 and exits the BA housing 200 via the outlet 250. Accordingly, the beneficial agents are dissolved by the free flow of water into the BA device and by the action of the compression component.

During dissolution, the compression component 235 continually exerts pressure upon the dry BA bed. Thus, the BA bed 260 is continually compacted as it dissolves, thereby avoiding channeling and ensuring continuous and even dissolution. This facilitates a continuous flow-through process and achieves the desired dissolution without the need for agitation or heating.

In alternative embodiment, additional agents can be segregated into separate devices, which can be used in combination, by connecting the various BA devices to each other in series.

The purification segment 100 and the BA device 200 can be resealable to allow replacement of depleted components or replenishment of beneficial agents. This could be accomplished by incorporation of a screw top, a snap fit, or a bayonet fit between the cover and housing of either segment.

Although the foregoing invention has been described in terms of certain preferred embodiments, other embodiments will be apparent to those of ordinary skill in the art. Additionally, other combinations, omissions, substitutions and modification will be apparent to the skilled artisan, in view of the disclosure herein. Accordingly, the present invention is not intended to be limited by the recitation of the preferred embodiments, but is instead to be defined by reference to the appended claims.

What is claimed is:

1. A point-of-use apparatus for producing fortified medical grade drinking water, comprising:
a purification segment comprising a housing defining a fluid flow path therethrough from an inlet port to an outlet port;
a depth filter positioned adjacent to the inlet;
a dissociable ion removal component;
an organic retention component;
a microfiltration component;
an outlet, wherein water emerging from the outlet contains equal to or less than the water-borne contaminants listed in Table 1; and
a beneficial agent delivery device connected to the outlet of the housing, wherein the device comprises at least one beneficial agent bed adjacent to at least one compression component.

2. The apparatus of claim 1, wherein the housing is between 1.5 and 3 inches in height.

3. The apparatus of claim 1, wherein the depth filter has a pore size from 1 to 500 microns.

4. The apparatus of claim 1, wherein the dissociable ion removal component comprises an ion exchanger.

5. The apparatus of claim 4, wherein the deionization resin bed comprises a mixed bed of anion-exchangers and cation-exchangers.

6. The apparatus of claim 1, wherein the organic retention component comprises a carbon bed.

7. The apparatus of claim 1, wherein the microfiltration component comprises a microfiltration membrane having a porosity of between 0.1 and 1 micron.

8. The apparatus of claim 1, wherein the permeable membrane comprises an ultrafiltration membrane having a nominal cut-off porosity between about 10,000 and 15,000 molecular weight.

9. The apparatus of claim 1, wherein water passed through the housing has a total organic content of less than about 1 ppm; conductivity of less than about 5.0 μSiemens; pH between about 4.5 and 7.5; fewer than about 12 particles/mL of particles smaller than 10 μm; and lower than about 0.025 ng/mL of endotoxins.

10. A point-of-use apparatus for producing medical grade drinking water, comprising:
a purification segment comprising a housing defining a fluid flow path therethrough from an inlet port to an outlet port;
a depth filter positioned adjacent to the inlet;
a dissociable ion removal component;
an organic retention component;
a microfiltration component; and
an outlet, wherein water emerging from the outlet contains equal to or less than the water-borne contaminants listed in Table 1.

11. A method of producing fortified medical grade drinking water, comprising:
providing a point-of-use apparatus comprising a purification segment;
providing non-sterile water to an inlet of the purification segment under a feed pressure;
passing the water through the purification segment;
outputting medical grade drinking water from an outlet of the purification segment , wherein the purified water has an organic content, conductivity, pH level and particulate contamination level equal to or less than the parameters outline in Table 1; and
providing the medical grade drinking water to a beneficial agent delivery device, wherein the device comprises a compression component adjacent to at least one beneficial agent bed, and wherein said compression component applies pressure to the beneficial agent bed as the medical grade drinking water passes through the beneficial agent bed, causing the beneficial agents to dissolve without agitation in the medical grade drinking water.

12. The method of claim 11, further comprising imbibing the medical grade drinking water by a human being.

13. The method of claim 11, wherein dissolving one or more beneficial agents in the medical grade drinking water comprises passing the medical grade drinking water from the outlet into a beneficial agent delivery device housing dry formulations suitable for fortifying medical grade drinking water.

14. The method of claim 13, wherein the one or more beneficial agents comprise water soluble vitamins.

15. The method of claim 13, wherein the one or more beneficial agents comprise biocompatible minerals.

16. The method of claim 13, wherein the one or more beneficial agents comprise a protein supplement.

17. The method of claim 13, wherein the one or more beneficial agents comprise an analgesic.

18. The method of claim 13, wherein the one or more beneficial agents comprise a laxative.

19. The method of claim 11, wherein the fortified medical grade drinking water has a total organic content of less than about 500 ppb; conductivity of less than about 2.0 μSiemens; pH between about 4.5 and 7.5; fewer than about 12 particles/mL of particles greater than 10 μm; fewer than about 2 particles/mL of particles greater than 25 μm; and lower than about 0.025 ng/mL of endotoxins.
